(19) United States
(12) Patent Application Publication
(10) Pub. No.: US 2007/0292698 A1
(43) Pub. Date: Dec. 20, 2007

(54) Trimetaspheres as Dry Lubricants, Wet Lubricants, Lubricant Additives, Lubricant Coatings, Corrosion-Resistant Coatings and Thermally-Conductive Materials

(75) Inventor: Charles B. Gause, Providence, NC (US)

Correspondence Address: BUCHANAN, INGERSOLL & ROONEY PC, POST OFFICE BOX 1404, ALEXANDRIA, VA, 22313-1404, US

(73) Assignee: Luna Innovations Incorporated, Roanoke, VA (US)

(21) Appl. No.: 10/594,027

(22) PCT Filed: Mar. 25, 2005
(86) PCT No.: PCT/US05/10217

§ 371 Date: Jul. 23, 2007

Related U.S. Application Data
(60) Provisional application No. 60/556,430, filed on Mar. 26, 2004.

(51) Int. Cl. C10M 125/20; C10M 173/00; C23F 11/00; F16C 33/12

(52) U.S. Cl. 428/457; 106/14.44; 252/74; 508/151

(57) ABSTRACT

A₃₋ₙXₙN@C₈₀endohedral metallofullerenes used as or in lubricant, lubricant additive, corrosion-resistant, and thermally conductive materials are disclosed. Methods of making and using are provided.

### BACKGROUND

A variety of fullerene-based products including, for example, fullerene-based lubricants have been suggested. However, such products are not optimal because flllerenes are highly reactive and degrade and oxidize in ambient and elevated temperatures.

Endohedral metallofullerenes are described, for example, in U.S. Pat. No. 6,303,760. Additionally, the use of endohedral metallofullerene compounds in imaging and treatment methods is described, for example, in U.S. Pat. No. 6,471,942.

### SUMMARY

Lubricants comprising at least one trimetasphere, lubricant additives comprising at least one trimetasphere, lubricant coatings comprising at least one trimetasphere, corrosion-resistant coatings comprising at least one trimetasphere and thermally-conductive materials comprising at least one trimetasphere are provided, as well as methods of making and using the same.

In an exemplary embodiment, a lubricant comprising at least one trimetasphere is provided. In a preferred embodiment, the trimetasphere can have a water contact angle of between about 100 and about 120, and/or exhibit stability at temperatures up to about 500° F. to about 750° F. in air and up to about 2000° F. to about 2300° F. in a vacuum. In another preferred embodiment, the lubricant can be a wet or dry lubricant.

An exemplary method of making a lubricant comprises forming the lubricant so that it comprises at least one trimetasphere. In a preferred embodiment, the trimetasphere can have a water contact angle of between about 100 and about 120, and/or exhibit stability at temperatures up to about 500° F. to about 750° F. in air and up to about 2000° F. to about 2300° F. in a vacuum. In another preferred embodiment, the trimetasphere can be a wet or dry lubricant.

An exemplary method of lubricating an article comprises applying a lubricant comprising at least one trimetasphere to the article. In a preferred embodiment, the trimetasphere can have a water contact angle of between about 100 and about 120; and/or exhibit stability at temperatures up to about 500° F. to about 750° F. in air and up to about 2000° F. to about 2300° F. in a vacuum. In another preferred embodiment, the lubricant can be a wet or dry lubricant.

An exemplary lubricant additive comprises at least one trimetasphere. In a preferred embodiment, the trimetasphere can have a water contact angle of between about 100 and about 120; and/or exhibit stability at temperatures up to about 500° F. to about 750° F. in air and up to about 2000° F. to about 2300° F. in a vacuum. In another preferred embodiment, the additive can be formulated for use in a wet or dry lubricant.

An exemplary method of making a lubricant additive comprises formulating the additive to include at least one trimetasphere. In a preferred embodiment, the trimetasphere can have a water contact angle of between about 100 and about 120; and/or exhibit stability at temperatures up to about 500° F. to about 750° F. in air and up to about 2000° F. to about 2300° F. in a vacuum. In another preferred embodiment, the additive can be formulated for use in a wet or dry lubricant.

An exemplary method of lubricating an article, comprises applying a lubricant additive comprising at least one trimetasphere to the article. In a preferred embodiment, the trimetasphere can have a water contact angle of between about 100 and about 120; and/or exhibit stability at temperatures up to about 500° F. to about 750° F. in air and up to about 2000° F. to about 2300° F. in a vacuum. In another preferred embodiment, the lubricant can be a wet or dry lubricant.

An exemplary corrosion-resistant coating comprises at least one trimetasphere. In a preferred embodiment, the trimetasphere can have a water contact angle of between about 100 and about 120; and/or exhibit stability at temperatures up to about 500° F. to about 750° F. in air and up to about 2000° F. to about 2300° F. in a vacuum.

An exemplary method of inhibiting corrosion of an article, comprises applying at least one trimetasphere to the article. In a preferred embodiment, the trimetasphere can have a water contact angle of between about 100 and about 120; and/or exhibit stability at temperatures up to about 500° F. to about 750° F. in air and up to about 2000° F. to about 2300° F. in a vacuum.

An exemplary thermally-conductive material comprises at least one trimetasphere. In a preferred embodiment, the trimetasphere can have a water contact angle of between about 100 and about 120; and/or exhibit stability at temperatures up to about 500° F. to about 750° F. in air and up to about 2000° F. to about 2300° F. in a vacuum. In another preferred embodiment, the trimetasphere can exhibit a thermal conductivity of about 0.1 W/mK to about 0.5 W/mK at about 300 K.

An exemplary method of making a thermally conductive material comprises forming the material so that the material comprises at least one trimetasphere. In a preferred embodiment, the trimetasphere can have a water contact angle of between about 100 and about 120; and/or exhibit stability at temperatures up to about 500° F. to about 750° F. in air and up to about 2000° F. to about 2300° F. in a vacuum. In another preferred embodiment, the trimetasphere can exhibit a thermal conductivity of about 0.1 W/mK to about 0.5 W/mK at about 300 K.

### BRIEF DESCRIPTION OF THE DRAWINGS

FIG. 1 is a schematic of two empty cage fullerenes.

FIG. 2 is a schematic of a classic metallofullerene.

FIG. 3 is a schematic of a nanotrimetasphere.

FIG. 4A is a graph depicting the binding energy of Sc₃N@C₈₀ before being heated.

FIG. 4B is a graph depicting the binding energy of Sc₃N@C₈₀ after being heated in air to 400° C.

FIG. 4C is a post-heating image of the Sc₃N@C₈₀ morphology.

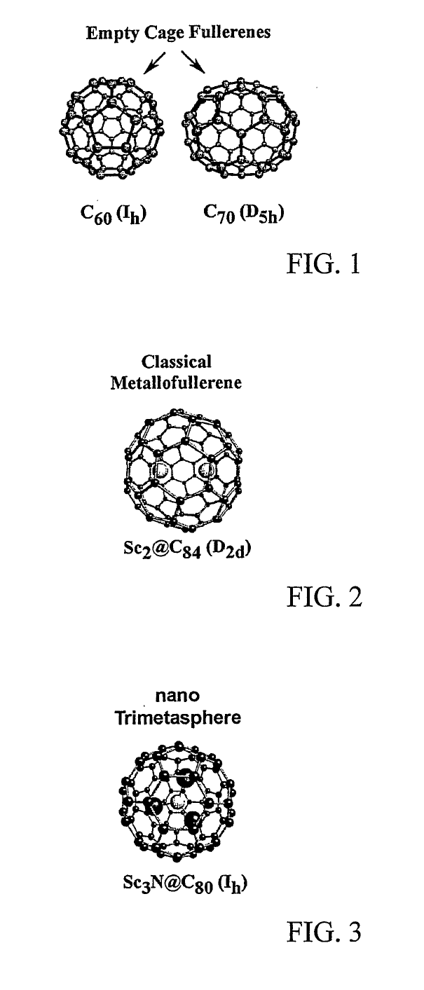

### DETAILED DESCRIPTION

Lubricants comprising at least one trimetasphere, lubricant additives comprising at least one trimetasphere, lubricant coatings comprising at least one trimetasphere, corrosion-resistant coatings comprising at least one trimetasphere, corrosion-resistant additives comprising at least one trimetasphere and thermally-conductive materials comprising at least one trimetasphere are provided. Methods of making such lubricants, additives, coatings and materials and methods of lubricating articles and inhibiting corrosion are also provided.

The term “trimetasphere” refers to a member of a family of endohedral metallofullerenes having the general formula A₃₋ₙXnN@Cm(n=0-3).

The term “endohedral” refers to the encapsulation of atoms inside the fallerene cage network. Accepted symbols for elements and subscripts to denote numbers of elements are used herein. Generally, all elements to the right of an @ symbol are part of the fullerene cage network, while all elements listed to the left of the @ symbol are contained within the fullerene cage. For example, under the notation Sc₃N@C₈₀, the Sc₃N trimetallic nitride is situated within a C₈₀ fullerene cage.

The term “lubricant” refers to any substance capable of reducing friction, heat and/or wear when introduced between solid surfaces including, for example, dry and wet lubricants. Exemplary lubricants can include, for example, lubricants for metals, metal alloys and semiconducitng materials. Exemplary lubricants can be particularly useful in automotive, aircraft, space and ultra-high vacuum applications. In particular, exemplary lubricants may be suitable for use in ball bearing and/or sliding bearing applications, including, for example, in automotive engines, transmission systems, pumps, aerospace, and numerous other applications.

In exemplary embodiments, wherein a trimetasphere is used in a solid or dry lubricant, additive or coating, it may be beneficial for the lubricant, additive or coating to exhibit properties such as, for example, low surface energy, high chemical stability, weak intermolecular bonding, good transfer film forming capability and high load bearing capacity. In other exemplary embodiments, at least one trimetasphere can be combined with, for example, known solid or dry lubricants such as, for example, graphite, metal dichalcogenides, MX₂ (where M is molybdenum or tungsten and X is sulphur or selenium), MoS₂, polytetrafluoroethylene (PTFE), metal powders, including bronze powder, bronze-graphite powder, ferrous-graphite powder, and other alloy powders, talc, molybdenum disulfide, tungsten disulfide, niobium disulfide, boron nitride, ditellurides, diselenides of group V and VI metals, combinations thereof and the like.

In further exemplary embodiments, lubricants and/or lubricant coatings can be made by combining at least one trimetasphere with an organic fluid or a mixture of organic fluids such as, for example, an oil, a molten wax, combinations thereof and the like. In such embodiments, the resulting lubricant or coating may be a wet lubricant.

Exemplary lubricants, lubricant additives and lubricant coatings can be used and/or made using a variety of known techniques including, for example, those disclosed in U.S. Pat. No. 6,710,020, which is hereby incorporated by reference in its entirety.

The term “corrosion” refers to the action, process or effect of wearing away gradually by, for example, chemical action. Exemplary corrosion-resistant coatings can be prepared using a variety of known coating processes including, for example, powder coating, galvanizing, vapor deposition, chemical vapor deposition, plasma deposition, electroplating, diffusion coating by simultaneous deposition, e-beam treatment, physical vapor deposition, ionic self-assembly, sputtering, other metal organic deposition (MOD) techniques, sol-gel deposition, laser assisted deposition, combinations thereof and the like. In addition, in exemplary embodiments, one or more trimetaspheres can be introduced to known corrosion-resistant coatings as an additive to provide enhanced corrosion-resistance.

The term “thermally-conductive” means the quality or power of conducting or transmitting thermal energy or heat. In exemplary embodiments, at least one trimetasphere can be used in a thermally-conductive material, coating or additive. In some exemplary embodiments, the at least one trimetasphere can be combined with one or more known thermally-conductive materials including, but not limited to, a metal such as, for example, copper, silver, gold, chrome/aluminum, superalloys, ziralloy, aluminum, steel, tungsten, molybdenum, tantalum and brass, a metal oxide such as, for example, aluminum oxide, magnesium oxide and beryllium oxide, a nitride such as, for example, aluminum nitride and silicon nitride, a carbonate, a polycarbonate, a carbide, a polysilicon, a chemical vapor deposited (CVD) diamond, a metal-coated resin, a graphitized carbon fiber, a non-graphitized carbon fiber, natural graphite, synthetic graphite, mesocarbon microbeads, combinations thereof and the like.

Fullerenes are a family of closed-caged molecules made up of carbon atoms. The closed-cage molecules consist of a series of five and six member carbon rings. The fullerene molecules can contain 500 or more carbon atoms. The most common fullerene is the spherical C₆₀ molecule taking on the familiar shape of a soccer ball.

Fullerenes are typically produced by an arc discharge method using a carbon rod as one or both of the electrodes in a Krätscluner-Huffman generator. Krätschmer, W. et al., Kim. Phys. Lett., 170, 167-170 (1990), which is hereby incorporated by reference in its entirety. Typically, the generator has a reaction chamber and two electrodes. The reaction chamber is evacuated and an inert gas is introduced in the reaction chamber at a controlled pressure. A potential is applied between the electrodes in the chamber to produce an arc discharge. The arc discharge forms a carbon plasma in which fullerenes of various sizes are produced.

Many derivatives of fullerenes have been prepared including encapsulating metals inside a fullerene cage. Metal encapsulated fullerenes are typically prepared by packing a cored graphite rod with the metal oxide of the metal to be encapsulated in the fullerene cage. The packed graphite rod is placed in the generator and arc discharged to produce fullerene products. The formation of metal encapsulated fullerenes is a complicated process and typically yields only very small amounts of metal fullerenes.

Fullerenes and their derivatives are useful as superconductor materials, catalysts, and non-linear optical materials. Fullerene compounds can also find utility as molecular carriers for drugs or catalysts. Fullerenes containing radio-active materials can be useful in missile therapy for cancer and as a radionuclide tracer.

Such endohedral metallofullerenes can be formed by a trimetallic nitride template process (“TNT”). In the general formula A₃₋ₙXₙN@Cₘ, A is a metal, X is a second trivalent metal, n is an integer from 0 to 3, and m is an even integer from about 60 to about 200. The integer m can take on values ranging from about 60 to about 100. Typically, m is about 68, about 78, or about 80. Further, x can be a trivalent metal and can have an ionic radius below about 0.095 nm, and A can be a trivalent metal having an ionic radius below about 0.095 nm.

A can be an element selected from the group consisting of a rare earth element and a group IIIB element. Further, A can be selected from the group consisting of scandium, yttrium, lanthanum, gadolinium, holmium, erbium, thulium, and ytterbium. X can be an element selected from the group consisting of a rare earth element and a group IIIB element. Still further, X can be selected from the group consisting of scandium, yttrium, lanthanum, gadolinium, holmium, erbium, thulium and ytterbium. An exemplary method of making a trimetallic nitride endrohedral metallofullerene can include charging a reactor with a first metal, carbon, and nitrogen; and reacting the nitrogen, the first metal, and the carbon in the reactor to form an endohedral metallofullerene. The nitrogen can be introduced in the reactor in the form of a nitrogen gas and the first metal and carbon can be introduced into the reactor in the form of a rod filled with a mixture of a first metal oxide and graphite, wherein the first metal oxide is an oxide of the first metal.

The first metal can be selected from the group consisting of a rare earth element and a group IIIB element. Typically, the first metal is selected from the group consisting of scandium, yttrium, lanthanum, gadolinium, holmium, erbium, thulium and ytterbium. The first metal can have an ionic radius below about 0.095 nm. Further, the first metal can be a trivalent metal.

The mixture comprises from about 1% to about 5% first metal oxide by weight. Typically, the mixture comprises about 3% first metal oxide by weight.

The method further includes reacting the nitrogen, carbon, and first metal further comprising vaporizing the carbon and the first metal in the presence of the nitrogen. The nitrogen can be introduced into the reactor in the form of a carbon nitride or a metal nitride wherein the metal nitride contains the metal to be encapsulated in the fullerene cage.

Still further, the method includes adding about 1 to about 450 mg of cobalt oxide to the mixture of metal oxide in graphite. Typically, the mixture comprises from about 75 to about 225 mg of cobalt oxide.

The method further includes charging the reactor with a first metal, a second metal, carbon and nitrogen and reacting the second metal, the first metal, carbon, and nitrogen to produce the endohedral metallofallerene. In accordance with the present invention, the nitrogen can be introduced in the reactor in the form of nitrogen gas; and the first metal, the second metal, and the carbon are introduced into the reactor in the form of a rod filled with a mixture of a first metal oxide, a second metal oxide, and graphite wherein the first metal oxide is an oxide of the first metal and the second metal oxide is an oxide of the second metal.

The first metal is selected from the group consisting of a rare earth element and a group III element; and the second metal is selected from the group consisting of a rare earth element and a group IIIB element. Typically, the first metal is selected from the group consisting of scandium, yttrium, lanthanum, gadolinium, holmium, erbium, thulium and ytterbium; and the second metal is selected from the group consisting of scandium, yttrium, lanthanum, gadolinium, holmium, erbium, thulium and ytterbium. Further, the first and second metals can have an ionic radius below about 0.095 nm. Still further, the first and second metal can be trivalent metals.

The method can also include a mixture having from about 1% to about 5% first metal oxide by weight and from about 1% to about 5% second metal oxide by weight. Typically, the mixture has about 3% first metal oxide and about 2% second metal oxide by weight.

The method further includes reacting the nitrogen, carbon, first metal and second metal farther comprising vaporizing the carbon, first metal and second metal in the presence of the nitrogen. The nitrogen can be introduced in the reactor in the form of a carbon nitride or metal nitride wherein the metal nitride contains the metal to be encapsulated in the fullerene cage.

The mixture can have from about 1 to about 450 mg of cobalt oxide. Typically, the mixture has about 75 to about 225 mg of cobalt oxide. Additional detail concerning the properties of trimetaspheres and methods of synthesizing trimetaspheres can be found, for example, in U.S. Pat. No. 6,303,760, which is hereby incorporated by reference in its entirety.

Trimetaspheres can be used in ambient and high-temperature dry lubricants, lubricant additives, “wet” lubricants, lubricating films or coatings, corrosion inhibitors, corrosion-resistant coatings and/or additives, and thermally-conductive materials, for use, for example, in coatings and/or lubricants. Trimetaspheres are useful in these applications because of their high stability in oxidizing environments (e.g., up to temperatures of about 300° C. to about 400° C. in air and about 1000° C. to about 1600° C. in a vacuum). Likewise, trimetasphere thin films are suitable for such purposes because they are extremely hydrophobic, exhibiting a water contact angle of about 100 to about 120, preferably about 105 to about 115, more preferably about 106 to about 112, and most preferably about 110. Thus, exemplary trimetaspheres can exhibit a water contact angle which is comparable to the water contact angle of Teflon®.

Although conventional C₆₀ fullerenes can be suitable lubricants, they are highly reactive and degrade and oxidize in ambient and elevated temperatures in air. (The proposed use of fullerenes as lubricants is disclosed, for example, in Zhang P., Xue Q., Du Z. and Zang Z., Wear, 254(10), 959-964, 2003, which is hereby incorporated by reference in its entirety.) Trimetaspheres, however, exhibit high thermal stability and chemical inertness when compared to conventional empty-cage fullerenes. Accordingly, trimetaspheres can be used, for example, as lubricants, lubricant additives and lubricant coatings in harsh environments such as, for example, in military applications.

A comparison of the stability of trimetaspheres to conventional C₆₀ fallerenes is presented in the following table, which provides the degradation temperature of each material in air and in a vacuum.

| | | Trimetasphere (e.g., |
|---|---|---|
| | C₆₀ | Sc₃N@C₈₀ |
| Degradation | 350° F. (175° C.)¹¹ | 750° F. (400° C.)¹¹¹ |
| Temperature | | |
| Degradation | N/A | >2400° F. (>1300° C.) |
| Temperature | | |
| in Vacuum | | |

The degradation temperature of C₆₀ is disclosed, for example, in Chibante L P F, Pay C. y. Pierson M. L. et al., Carbon 31(1), 185-193, 1993, which is hereby incorporated by reference in its entirety.

Accordingly, while empty-cage fallerenes have previously been proposed for use as lubricants, Applicants have discovered that metallic nitride based carbonaceous nano materials (i.e., trimetaspheres) are superior because of their chemical, electrical and structural characteristics. Structurally, trimetaspheres as shown, for example, in FIG. 3, have a spherical, icosahedral network of, for example, about 80 carbon atoms that form a carbon cage. Inside the cage is a stabilizing metallic nitride atomic cluster that permits the trimetasphere to be formed (e.g., Sc₃N@C₈₀). The stabilizing influence of the encaged metallic nitride (“trimer”) permits extreme temperature compatibility at temperatures up to about 1000° F. to about 1500° F. in a vacuum, preferably up to about 2000° F. in a vacuum, more preferably up to about 2100° F. in a vacuum, and most preferably up to about 2300° F. in a vacuum. Additionally, the stabilizing influence of the encaged metallic nitride permits temperature compatibility in air up to temperatures of about 500° F., preferably about 600° F., more preferably about 700° F. and most preferably about 750° F.

Trimetaspheres can also provide corrosion inhibition. Corrosion testing has been done with a C₆₀ coating on iron. This testing indicates that C₆₀ coatings do not alter the corrosion potential, but can reduce corrosion rates. See Sittner, F. Enders, B., Jungclas, H., Ensinger, W., Corrosion Properties of Ion Beam Modified Fullerene Thin Films on Iron Substrates, Surface and Coatings Technology, 2002, 158-159: p. 368-372, which is hereby incorporated by reference in its entirety. Because the C₆₀ coating did not shift the potential to more noble (positive) potentials, detrimental galvanic coupling is not expected. Because of their high chemical inertness and stability, however, trimetaspheres provided, for example, in the form of coatings, can provide reasonable barrier properties.

Additionally, trimetaspheres can provide significant thermal conductivity and, therefore, can be used in thermally-conductive materials or as thermally-conductive material additives for incorporation into various fluids and composites. In particular, it is believed that trimetaspheres exhibit thermal conductivities of about 0.1 W/mK to about 0.0.5 W/mK, more preferably about 0.2 W/mK to about 0.45 W/mK, and most preferably about 0.4 W/mK at about 300° Kelvin.

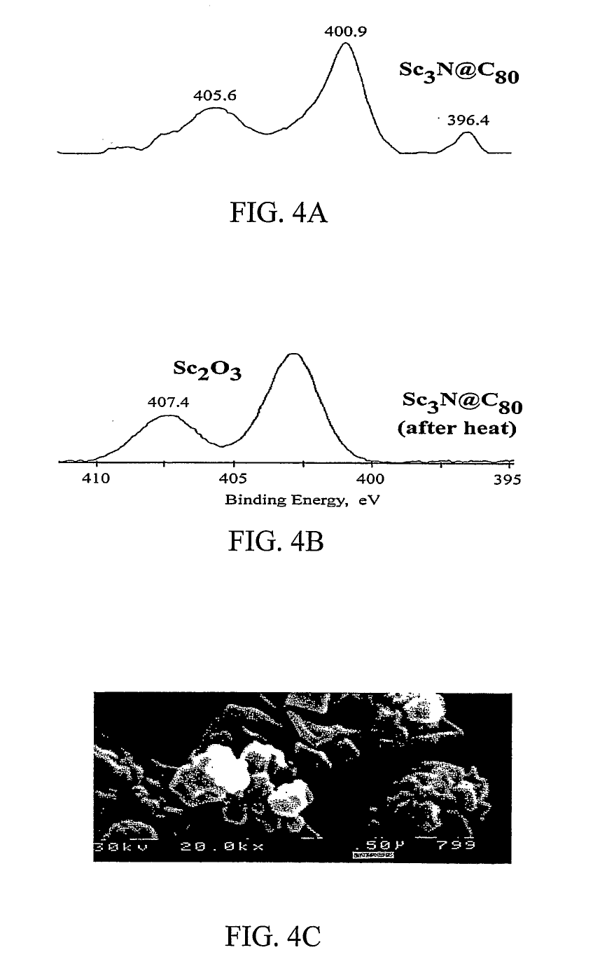

FIGS. 4A, B and C provide information concerning the binding energy of an exemplary trimetasphere and its morphology. FIG. 4A depicts the binding energy of an exemplary trimetasphere before heating. FIG. 4B depicts the exemplary trimetasphere's binding energy after being heated in air to about 400° C. Finally, FIG. 4C provides an image of the trimetasphere's morphology after heating. These figures show that a nanostructured oxide coating is formed after the cage is removed and demonstrates the stability of the trimetasphere at 400° C., indicating that the trimetasphere can be used as a high-temperature lubricant in air.

### EXAMPLE

### Example 1

Contact angle of a trimetasphere is measured by conducting three measurements on one end in the center third of the trimetasphere sample. The contact angles are measured to be 112°, 106° and 112°.

Half of the sample is coated by plasma deposition. The deposition is conducted at 100 watts RF power, He flow of about 111 pm, bubbler flow is 40 (chemical DC200.65CST) and the carrier speed is “0”. The measured contact angles are 82°, 82°, 82°.

The carrier is reversed and the other half of the sample is treated with plain helium plasma (using all of the same conditions except that the bubbler valve is closed). The contact to angle is too low to be measured, i.e., the water drop spreads.

While a detailed description has been provided with reference to specific embodiments, it will be apparent to those skilled in the art that various changes and modifications can be made, and equivalents employed, without departing from the scope of the appended claims.

What is claimed is:

1. A lubricant comprising at least one trimetasphere.

2. The lubricant of claim 1, wherein the at least one trimetasphere has a water contact angle of between about 106 and about 112.

3. The lubricant of claim 1, wherein the at least one trimetasphere is stable at temperatures up to about 750° F. in air and up to about 2300° F. in a vacuum.

4. The lubricant of claim 1, wherein the lubricant is a dry or wet lubricant.

5. The lubricant of claim 6, wherein when the lubricant is a dry lubricant, the lubricant further comprises at least one member selected from the group consisting of a graphite, a metal dichalogenide, MX₂ (wherein M=molybdenum or tungsten and X=sulphur or selenium), MoS₂, PTFE, a metal powder, talc, molybdenum disulfide, tungsten disulfide, niobium disulfide, boron nitride, ditelluride, diselenide of a Group V or VI metal and combinations thereof.

6. The lubricant of claim 4, wherein when the lubricant is a wet lubricant the lubricant further comprises at least one member selected from the group consisting of an organic fluid and a mixture of organic fluids.

7. A method of making a lubricant, the method comprising forming the lubricant so that it comprises at least one trimetasphere.

8. The method of claim 7, wherein the at least one trimetasphere has a water contact angle of between about 106 and about 112.

9. The method of claim 7, wherein the at least one trimetasphere is stable at temperatures up to about 750° F. in air and up to about 2300° F. in a vacuum.

10. The method of claim 7, wherein the lubricant is a dry or wet lubricant.

11. The method of claim 10, wherein when the lubricant is a dry lubricant the lubricant further comprises at least one member selected from the group consisting of a graphite, a metal dichalogenide, MX₂ (wherein M=molybdenum or tungsten and X=sulphur or selenium), MoS₂, PTFE, a metal powder, talc, molybdenum disulfide, tungsten disulfide, niobium disulfide, boron nitride, ditelluride, diselenide of a Group V or VI metal and combinations thereof.

12. The lubricant of claim 10, wherein when the lubricant is a wet lubricant the lubricant further comprises at least one member selected from the group consisting of an organic fluid and a mixture of organic fluids.

13. A method of lubricating an article, the method comprising applying a lubricant comprising at least one trimetasphere to the article.

14. The method of claim 13, wherein the at least one trimetasphere has a water contact angle of between about 106 and about 112.

15. The method of claim 13, wherein the at least one trimetasphere is stable at temperatures of up to about 750° F. in air and up to about 2300° F. in a vacuum.

16. The method of claim 13, wherein the lubricant is a dry or wet lubricant.

17. The method of claim 16, wherein when the lubricant is a dry lubricant, the lubricant further comprises at least one member selected from the group consisting of a graphite, a metal dichalogenide, MX₂ (wherein M=molybdenum or tungsten and X=sulphur or selenium), MoS₂, PTFE, a metal powder, talc, molybdenum disulfide, tungsten disulfide, niobium disulfide, boron nitride, ditelluride, diselenide of a Group V or VI metal and combinations thereof.

18. The lubricant of claim 16, wherein when the lubricant is a wet lubricant the lubricant further comprises at least one member selected from the group consisting of an organic fluid and a mixture of organic fluids.

19. A lubricant additive comprising at least one trimetasphere.

20. The additive of claim 19, wherein the at least one trimetasphere has a water contact angle of between about 106 and about 112.

21. The additive of claim 19, wherein the at least one trimetasphere is stable at temperatures up to about 750° F. in air and up to about 2300° F. in a vacuum.

22. The additive of claim 19, wherein the additive is formulated so that it can be added to a wet or dry lubricant.

23. The additive of claim 22, wherein when the lubricant is selected from the group consisting of a graphite, a metal dichalogenide, MX₂ (wherein M=molybdenum or tungsten and X=sulphur or selenium), MoS₂, PTFE, a metal powder, talc, molybdenum disulfide, tungsten disulfide, niobium disulfide, boron nitride, ditelluride, diselenide of a Group V or VI metal and combinations thereof.

24. The lubricant of claim 22, wherein when the lubricant is a wet lubricant the lubricant further comprises at least one member selected from the group consisting of an organic fluid and a mixture of organic fluids.

25. A method of making a lubricant additive, the method comprising formulating the additive to comprise at least one trimetasphere.

26. The method of claim 25, wherein the at least one trimetasphere has a water contact angle of between about 106 and about 112.

27. The method of claim 25, wherein the at least one trimetasphere is stable at temperatures up to about 750° F. in air and up to about 2300° F. in a vacuum.

28. The method of claim 25, wherein the additive is formulated for use in a wet or dry lubricant.

29. The method of claim 28, wherein when the lubricant is a dry lubricant, the lubricant further comprises at least one member selected from the group consisting of a graphite, a metal dichalogenide, MX₂ (wherein M=molybdenum or tungsten and X=sulphur or selenium), MoS₂, PTFE, a metal powder, talc, molybdenum disulfide, tungsten disulfide, niobium disulfide, boron nitride, ditelluride, diselenide of a Group V or VI metal and combinations thereof.

30. The lubricant of claim 28, wherein when the lubricant is a wet lubricant the lubricant further comprises at least one member selected from the group consisting of an organic fluid and a mixture of organic fluids.

31. A method of lubricating an article, the method comprising applying a lubricant additive comprising at least one trimetasphere to the article.

32. A lubricant coating comprising the lubricant of claim 1.

33. A lubricant coating comprising the lubricant additive of claim 19.

34. A corrosion-resistant coating comprising at least one trimetasphere.

35. The coating of claim 34, wherein the at least one trimetasphere has a water contact angle of between about 106 and about 112.

36. The coating of claim 34, wherein the at least one trimetasphere is stable at temperatures up to about 750° F. in air and up to about 2300° F. in a vacuum.

37. A corrosion-resistant article, coated with the corrosion-resistant coating of claim 34.

38. A method of inhibiting corrosion of an article, the method comprising applying at least one trimetasphere to the article.

39. The method of claim 38, wherein the at least one trimetasphere has a water contact angle of between about 106 and about 112.

40. The method of claim 38, wherein the at least one trimetasphere is stable at temperatures up to about 750° F. in air and up to about 2300° F. in a vacuum.

41. A thermally-conductive material comprising at least one trimetasphere.

42. The material of claim 41, wherein the at least one trimetasphere has a water contact angle of between about 106 and about 112.

43. The material of claim 41, wherein the at least one trimetasphere is stable at temperatures up to about 750° F. in air and up to about 2300° F. in a vacuum.

44. The material of claim 41, wherein the at least one trimetasphere exhibits a thermal conductivity of about 0.4 W/mK at about 300 K.

45. A method of making a thermally-conductive material, the method comprising forming the material so that the material comprises at least one trimetasphere.
